(19) United States
(12) Patent Application Publication
(10) Pub. No.: US 2019/0140462 A1
(43) Pub. Date: May 9, 2019

(54) POWER SUPPLY DEVICE AND LIGHTING SYSTEM

(71) Applicant: SOCREAT ELECTRONICS TECHNOLOGY LIMITED, Shenzhen City, Guangdong (CN)

(72) Inventors: Zhenkun YIN, Shenzhen City, Guangdong (CN); Baichuan XIANG, Shenzhen City, Guangdong (CN); Junwu BAI, Shenzhen City, Guangdong (CN); Zhiwei LI, Shenzhen City, Guangdong (CN); Jie XIONG, Shenzhen City, Guangdong (CN)

(21) Appl. No.: 15/772,249

(22) PCT Filed: Jan. 12, 2018
(86) PCT No.: PCT/CN2018/072489

§ 371 Date: Apr. 30, 2018

(30) Foreign Application Priority Data
Jun. 12, 2017 (CN) 201710441142.5

(51) Int. Cl. H02J 7/00; H02J 7/35

(52) U.S. Cl. CPC H02J 7/0031; H02J 7/0036; H02J 7/0057; H02J 2007/004; H02J 7/35; H02J 2007/0037; H02J 7/0063

(57) ABSTRACT

Provided is a power supply device and a lighting system. The power supply device includes a solar panel, a storage battery, a charging management circuitry, a control circuitry, and a voltage-stabilized circuitry. The positive electrode of the solar panel, an input terminal of the charging management circuitry, and a first input terminal of the voltage-stabilized circuitry are interconnected. An output terminal of the charging management circuitry, the positive electrode of the storage battery, and a second input terminal of the voltage-stabilized circuitry are interconnected. An output terminal of the voltage-stabilized circuitry is connected to a power supply terminal of the control circuitry. A first control terminal of the control circuitry is connected to a controlled terminal of the charging management circuitry. The voltage-stabilized circuitry is configured for voltage stabilizing of the electric energy output from the solar panel or from the storage battery, and to output working power to the control circuitry. The control circuitry is configured to control a working state of the charging management circuitry, allowing the solar panel to charge the storage battery through the charging management circuitry. The technical solution of the present disclosure can enable the storage battery to be charged by the solar panel in the case where the battery voltage is 0V (low voltage).

### FIELD OF THE DISCLOSURE

The present disclosure relates to the field of lighting technology, and more particularly to a power supply device and a lighting system.

### BACKGROUND OF THE DISCLOSURE

An existing power supply device is illustrated in FIG. 1. It includes a solar panel, a charging management circuitry, a storage battery, a control circuitry, and a voltage-stabilized circuitry.

The solar panel is used to convert solar energy into electric energy, and then output the electric energy. The storage battery is used to store the electric energy output from the solar energy to power a load. The voltage-stabilized circuitry is used to stabilize the electric energy output from the storage battery and output working power to the control circuitry so as to control the control circuitry to turn on. The control circuitry is used to control the power supply status of the charging management circuitry, allowing the solar panel to charge the storage battery through the charging management circuitry.

In the power supply device, when voltage of the storage battery is reduced to such a level that it is insufficient to power the control circuitry, then the voltage-stabilized circuitry won't be able to output the working power supply of the control circuitry, so that the control circuitry cannot be turned on, disabling the solar panel from charging the storage battery via the charging management circuitry.

### SUMMARY OF THE DISCLOSURE

The present disclosure is to provide a power supply device, which aims to enable charging a storage battery under a low storage battery voltage condition.

In order to achieve the above aim, the present disclosure provides a power supply device that includes a solar panel, a storage battery, a charging management circuitry, a control circuitry and a voltage-stabilized circuitry. The positive electrode of the solar panel, an input terminal of the charging management circuitry, and a first input terminal of the voltage-stabilized circuitry are interconnected. An output terminal of the charging management circuitry, the positive electrode of the storage battery, and a second input terminal of the voltage-stabilized circuitry are interconnected. An output terminal of the voltage-stabilized circuitry is connected to a power supply terminal of the control circuitry. A first control terminal of the control circuitry is connected to a controlled terminal of the charging management circuitry. The voltage-stabilized circuitry is configured for voltage stabilizing of electric energy output from the solar panel or from the storage battery, and to output working power to the control circuitry. The control circuitry is configured to control a working state of the charging management circuitry, allowing the solar panel to charge the storage battery through the charging management circuitry.

The voltage-stabilized circuitry may include a first diode, a second diode, a Zener diode, a first capacitor, a second capacitor, and a first resistor. The anode of the first diode is the first input terminal of the voltage-stabilized circuitry. A second terminal of the first diode is connected to a first terminal of the first resistor. A second terminal of the first resistor, the cathode of the second diode, the cathode of the Zener diode, a first terminal of the first capacitor, and a first terminal of the second capacitor are interconnected. The connection node thereof is the output terminal of the voltage-stabilized circuitry. The anode of the second diode is the second input terminal of the voltage-stabilized circuitry. The anode of the Zener diode, a second terminal of the first capacitor, and a second terminal of the second capacitor are interconnected.

The charging management circuitry includes a third diode, a fourth diode, a second resistor, a third resistor, and a switching unit. A first terminal of the second resistor is connected to an input terminal of the switching unit, the connection node thereof is the input terminal of the charging management circuitry. An output terminal of the switching unit, the anode of the third diode and the anode of the fourth diode are interconnected. The cathode of the third diode is connected to the cathode of the fourth diode, and the connection node thereof is the output terminal of the charging management circuitry. A control terminal of the switching unit, a second terminal of the second resistor, and a first terminal of the third resistor are interconnected. A second terminal of the third resistor is the controlled terminal of the charging management circuitry.

The power supply device further includes a solar panel voltage collecting circuitry, an input terminal of the solar panel voltage collecting circuitry is connected to the positive electrode of the solar panel, and an output terminal of the solar panel voltage collecting circuitry is connected to a first input terminal of the control circuitry.

The solar panel voltage collecting circuitry includes a third capacitor, a fourth resistor, a fifth resistor, a sixth resistor, and a seventh resistor. A first terminal of the forth resistor is the input terminal of the solar panel voltage collecting circuitry. A second terminal of the fourth resistor is connected to a first terminal of the fifth resistor. A second terminal of the fifth resistor, a first terminal of the sixth resistor, a first terminal of the seventh resistor, and a first terminal of the third capacitor are interconnected. A second terminal of the sixth resistor is the output terminal of the solar panel voltage collecting circuitry. And a second terminal of the seventh resistor and a second terminal of the third capacitor are both grounded.

The power supply device further includes a storage battery voltage collecting circuitry, an input terminal of the storage battery voltage collecting circuitry is connected to the positive electrode of the storage battery, and an output terminal of the storage battery voltage collecting circuitry is connected to a second input terminal of the control circuitry.

The voltage acquisition circuitry of the storage battery includes an eighth resistor, a ninth resistor, and a fourth capacitor. A first terminal of the eighth resistor is the input terminal of the storage battery voltage collecting circuitry. A second terminal of the eighth resistor, a first terminal of the ninth resistor, and a first terminal of the fourth capacitor are interconnected, the connection node thereof is the output terminal of the storage battery voltage collecting circuitry. And a second terminal of the ninth resistor and a second terminal of the fourth capacitor are both grounded.

The control circuitry includes a control chip, a power pin of the control chip is the power supply terminal of the control circuitry, and a first controlling pin of the control chip is the first control terminal of the control circuitry.

The present disclosure also provides a lighting system which includes a discharging management circuitry and a power supply device described above. An input terminal of the discharging management circuitry is connected to the positive electrode of the storage battery. An output terminal of the discharging management circuitry is configured to output a load power supply voltage. A controlled terminal of the discharging management circuitry is connected to a second control terminal of the control circuitry. An adjusted terminal of the discharging management circuitry is connected to an adjusting terminal of the control circuitry. The power supply device includes the solar panel, the storage battery, the charging management circuitry, the control circuitry and the voltage-stabilized circuitry. The positive electrode of the solar panel, the input terminal of the charging management circuitry, and the first input terminal of the voltage-stabilized circuitry are interconnected. The output terminal of the charging management circuitry, the positive electrode of the storage battery and the second input terminal of the voltage-stabilized circuitry are interconnected. The output terminal of the voltage-stabilized circuitry is connected to the power supply terminal of the control circuitry. The first control terminal of the control circuitry is connected to the controlled terminal of the charging management circuitry. The voltage-stabilized circuitry is configured for voltage stabilizing of electric energy output from the solar panel or from the storage battery, and to output working power to the control circuitry. The control circuitry is configured to control the working state of the charging management circuitry, allowing the solar panel to charge the storage battery through the charging management circuitry.

The discharging management circuitry includes a tenth resistor, an eleventh resistor, a twelfth resistor, a thirteenth resistor, a fourteenth resistor, a fifteenth resistor, a first transistor, a second transistor, and a third transistor. A first terminal of the tenth resistor, a first terminal of the eleventh resistor, the positive electrode of a load, and the positive electrode of the storage battery are interconnected. A second terminal of the tenth resistor, a second terminal of the twelfth resistor and a controlled terminal of the first transistor are interconnected. A first terminal of the twelfth resistor is the controlled terminal of the discharging management circuitry. A second terminal of the eleventh resistor is connected to an input terminal of the first transistor. An output terminal of the first transistor, a second terminal of the fifteenth resistor, a first terminal of the second transistor and a first terminal of the third transistor are interconnected. A first terminal of the fifteenth resistor is connected to the positive electrode of the load. A controlled terminal of the second transistor, a second terminal of the thirteenth resistor, a first terminal of the fourteenth resistor, and a controlled terminal of the third transistor are interconnected. A first terminal of the thirteenth resistor is the adjusted terminal of the discharging management circuitry. And a second terminal of the fourteenth resistor, an output terminal of the second transistor, and an output terminal of the third transistor are all grounded.

The technical solution of the present disclosure utilizes a voltage-stabilized circuitry for voltage stabilizing of the electric energy output from a solar panel or a storage battery, and then outputting the working power necessary for a control circuitry, so that the control circuitry controls the operating state of a charging management circuitry, enabling the solar panel to charge the storage battery via the charging management circuitry. Thus, under low in which the storage battery conditions, the solar panel would be able to supply input power for the voltage-stabilized circuitry, so that the voltage-stabilized circuitry outputs the working power of the control circuitry, and the solar panel would then charge the storage battery via the charging management circuitry.

### BRIEF DESCRIPTION OF THE DRAWINGS

To more clearly illustrate the technical solutions according to various embodiments of the present disclosure or found in the prior art, the accompanying drawings intended for describing the embodiments herein or the prior art are briefly introduced as follows. Apparently, the accompanying drawings briefed in the following description reflect merely some embodiments according to the present disclosure, and persons of ordinary skill in the art can derive other drawings from the accompanying drawings without making creative efforts.

FIG. 1 is a schematic diagram illustrating an existing power supply device.

FIG. 2 is a block diagram illustrating a power supply device according to an embodiment of the present disclosure.

FIG. 3 is a schematic diagram illustrating a circuit structure of a power supply device according to another embodiment of the present disclosure.

FIG. 4 is a block diagram illustrating a lighting system according to an embodiment of the present disclosure.

FIG. 5 is a schematic diagram illustrating a circuit structure of a lighting system according to another embodiment of the present disclosure.

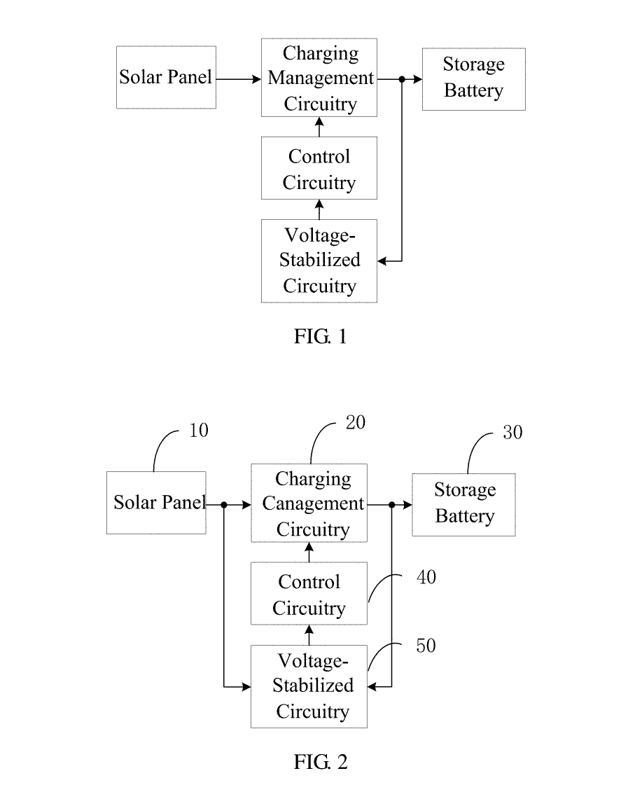

### DESCRIPTION OF REFERENCE NUMERALS APPEARING IN THE DRAWINGS

TABLE 1

| Reference | | Reference | | Reference | |
|---|---|---|---|---|---|
| Numeral | Name | Numeral | Name | Numeral | Name |
| 10 | Solar Panel | D1 | First Diode | R1 | First Resistor |
| 20 | Charging Management | D2 | Second Diode | R2 | Second Resistor |
| | Circuitry | | | | |
| 30 | Storage Battery | D3 | Third Diode | R3 | Third Resistor |
| 40 | Control Circuitry | D4 | Forth Diode | R4 | Forth Resistor |
| 50 | Voltage-stabilized | DZ | Zener Diode | R5 | Fifth Resistor |
| | circuitry | | | | |
| 60 | Solar panel voltage | U | Control Chip | R6 | Sixth Resistor |
| | collecting circuitry | | | | |
| 70 | Storage battery voltage | C1 | First Capacitor | R7 | Seventh Resistor |
| | collecting circuitry | | | | |
| 80 | Discharging | C2 | Second Capacitor | R8 | Eighth Resistor |
| | Management Circuitry | | | | |
| 21 | Switching Unit | C3 | Third Capacitor | R9 | Ninth Resistor |
| R13 | Thirteenth Resistor | C4 | Forth Capacitor | R10 | Tenth Resistor |
| R14 | Fourteenth Resistor | Q1 | First Transister | R11 | Eleventh Resistor |
| R15 | Fifteenth Resistor | Q2 | Second Transister | R12 | Twelfth Resistor |
| | | Q3 | Third Transister | | |

Various implementations, functional features, and advantages of the present disclosure will now be described in further detail with reference to the accompanying drawings and some illustrative embodiments.

### DETAILED DESCRIPTION OF THE EMBODIMENTS

The technical solutions of the embodiments of the present disclosure will be clearly and completely described in the following with reference to the accompanying drawings. It is obvious that the embodiments to be described are only a part rather than all of the embodiments of the present disclosure. All other embodiments obtained by persons skilled in the art based on the embodiments of the present disclosure without creative efforts shall fall within the protection scope of the present disclosure.

It is to be noted that, the descriptions, such as the “first”, the “second” in the present disclosure, can only be used for describing the aim of description, and cannot be understood as indicating or suggestting relative importance or impliedly indicating the number of the indicated technical character. Therefore, the character indicated by the “first”, the “second” can express or impliedly include at least one character. In addition, the technical proposal of each exemplary embodiment can be combined with each other, however the technical proposal must base on that the ordinary skill in that art can realize the technical proposal, when the combination of the technical proposals occurs contradiction or cannot realize, it should consider that the combination of the technical proposals does not existed, and is not contained in the protection scope required by the present disclosure.

The present disclosure provides a power supply device that can enable a storage battery 30 being charged by a solar panel 10 under a low storage battery condition. In detail, referring to the following embodiments.

Referring to FIG. 2, in this embodiment, a power supply device includes a solar panel 10, a storage battery 30, a charging management circuitry 20, a control circuitry 40 and a voltage-stabilized circuitry 50. The positive electrode of the solar panel 10, an input terminal of the charging management circuitry 20, and a first input terminal of the voltage-stabilized circuitry 50 are interconnected. An output terminal of the charging management circuitry 20, the positive electrode of the storage battery 30 and a second input terminal of the voltage-stabilized circuitry 50 are interconnected. An output terminal of the voltage-stabilized circuitry 50 is connected to a power supply terminal of the control circuitry 40. A first control terminal of the control circuitry 40 is connected to a controlled terminal of the charging management circuitry 20. The voltage-stabilized circuitry 50 is configured for voltage stabilizing of electric energy output from the solar panel 10 or the storage battery 30, and to output working power to the control circuitry 40. The control circuitry 40 is configured to control a working state of the charging management circuitry 20, allowing the solar panel 10 to charge the storage battery 30 through the charging management circuitry 20.

Specifically, during operation of the power supply device, as long as the voltage-stabilized circuitry 50 can obtain input power from the solar panel 10, the voltage regulator circuitry 50 can output working power to the control circuitry 40. The control circuitry 40 is turned on and controls the working state of the charging management circuitry 20, allowing the solar panel 10 to charge the storage battery 30 through the charging management circuitry 20. In this way, even if the voltage of the storage battery 30 is reduced to 0 V, the voltage-stabilized circuitry 50 can still supply power to the control circuitry 40, and the solar panel 10 can still charge the storage battery 30 through the charging management circuitry 20.

The technical solution of the present disclosure utilizes the voltage-stabilized circuitry 50 to stabilize the electric energy output from the solar panel 10 or from the storage battery 30, and to output the working power to the control circuitry 40, so that the control circuitry 40 controls the working state of the charging management circuitry 20, allowing the solar panel 10 to charge the storage battery 30 via the charging management circuitry 20. In this way, under a low storage battery 30 voltage condition, the solar panel 10 can provide input power for the voltage-stabilized circuitry 50, so that the voltage-stabilized circuitry 50 outputs the working power to the control circuitry 40, and the solar panel 10 charges the storage battery 30 via the charging management circuitry 20.

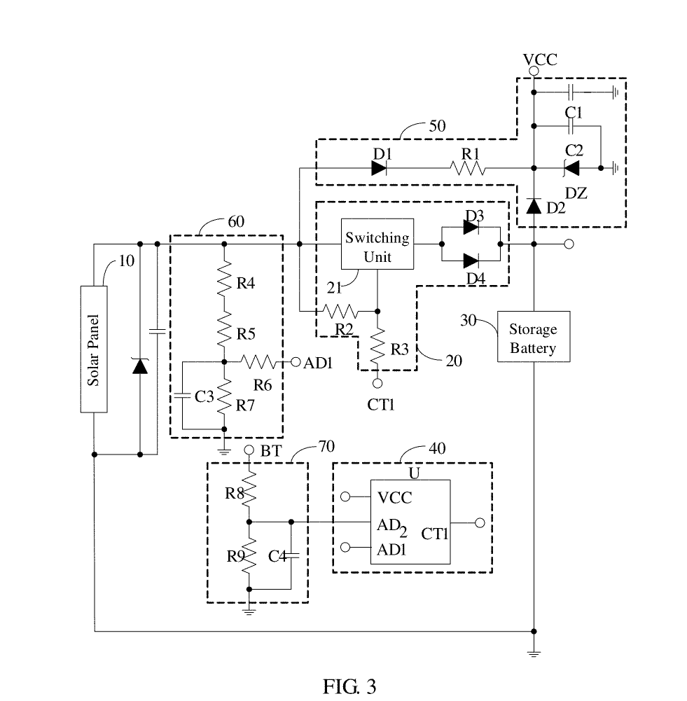

Optionally, referring to FIG. 3, in another embodiment, the voltage-stabilized circuitry 50 includes a first diode D1, a second diode D2, a Zener diode DZ, a first capacitor C1, a second capacitor C2, and a first resistor R1. The anode of the first diode D1 is the first input terminal of the voltage-stabilized circuitry 50. A second terminal of the first diode D1 is connected to a first terminal of the first resistor R1. A second terminal of the first resistor R1, the cathode of the second diode D2, the cathode of the Zener diode DZ, a first terminal of the first capacitor C1, and a first terminal of the second capacitor C2 are interconnected, and the connection node thereof is the output terminal of the voltage-stabilized circuitry 50. The anode of the second diode D2 is the second input terminal of the voltage-stabilized circuitry 50. The anode of the Zener diode DZ, a second terminal of the first capacitor C1, and a second terminal of the second capacitor C2 are interconnected.

Specifically, during operation of the voltage-stabilized circuitry 50, the electric energy output by the solar panel 10 is output to the output terminal of the voltage-stabilized circuitry 50 via the first diode D1. The electric energy output by the storage battery 30 is output to the output terminal of the voltage-stabilized circuitry 50 via the second diode D2. The output voltage of the voltage-stabilized circuitry 50 is equal to the regulated voltage value of the Zener diode DZ.

Optionally, referring to FIG. 3, in another embodiment, the charging management circuitry 20 includes a third diode D3, a fourth diode D4, a second resistor R2, a third resistor R3, and a switching unit 21. A first terminal of the second resistor R2 is connected to an input terminal of the switching unit 21, and the connection node thereof is the input terminal of the charging management circuitry 20. An output terminal of the switching unit 21, the anode of the third diode D3 and the anode of the fourth diode D4 are interconnected. The cathode of the third diode D3 is connected to the cathode of the fourth diode D4, and the connection node thereof is the output terminal of the charging management circuitry. A controlled terminal of the switching unit 21, a second terminal of the second resistor R2 and a first terminal of the third resistor R3 are interconnected. A second terminal of the third resistor R3 is the controlled terminal of the charging management circuitry 20.

The switching unit 21 may be a switching transistor or a switching chip, which is not limited herein. When the controlled terminal of the switching unit 21 receives a high-level signal, the input terminal of the switching unit 21 is connected to the output terminal; and when the controlled terminal of the switching unit 21 receives a low-level signal, the switching unit's 21 input terminal and output terminal are disconnected.

Specifically, during operation of the charging management circuitry 20, if the voltage of the second terminal of the third resistor R3 is high level, then when the controlled terminal of the switching unit 21 receives a high level voltage, the input terminal is connected to the output terminal of the switching unit 21, the electric energy output from the solar panel 10 is input to the storage battery 30 via the charging management circuitry 20, so as to charge the storage battery 30. During the whole process, the third diode D3 and the fourth diode D4 play a role of anti-reverse irrigation, so as to prevent the electric energy output by the storage battery 30 from being input to the solar panel 10 through the charging management circuitry 20.

Further, referring to FIG. 3, in another embodiment, the power supply device further includes a solar panel 10 voltage collecting circuitry, an input terminal of the solar panel 10 voltage collecting circuitry is connected to the positive electrode of the solar panel 10, and an output terminal of the solar panel 10 voltage collecting circuitry is connected to a first input terminal of the control circuitry 40.

The solar panel voltage collecting circuitry 60 is configured for collecting output voltage of the solar panel 10 and to output corresponding acquisition signal to the control circuitry 40, so that the control circuitry 40 controls the working state of the charging management circuitry 20 according to the output voltage of the solar panel 10.

It can be understood that, when there is sufficient sunlight during the daytime, the output voltage of the solar panel 10 is relatively high, and the value corresponding to the acquisition signal received by the control circuitry 40 is relatively large; when the sunlight is insufficient during the night, the output voltage of the solar panel 10 is relatively low, and the value corresponding to the acquisition signal received by the control circuitry 40 is relatively small. Thus, the control circuitry 40 can determine whether it is day or night according to the acquisition signal output by the solar panel voltage collecting circuitry 60, and control the solar panel 10 to charge the storage battery 30 through the charging management circuitry 20 during the day; and control not to charge the storage battery 30 during the night. Thereby, the charging efficiency of the storage battery 30 is increased, and the service life of the storage battery 30 is extended.

Optionally, referring to FIG. 3, in another embodiment, the solar panel 10 voltage collecting circuitry comprises a third capacitor C3, a fourth resistor R4, a fifth resistor R5, a sixth resistor R6, and a seventh resistor R7. A first terminal of the forth resistor R4 is the input terminal of the solar panel 10 voltage collecting circuitry. A second terminal of the fourth resistor R4 is connected to a first terminal of the fifth resistor R5. A second terminal of the fifth resistor R5, a first terminal of the sixth resistor R6, a first terminal of the seventh resistor R7 and a first terminal of the third capacitor C3 are interconnected. A second terminal of the sixth resistor R6 is the output terminal of the solar panel 10 voltage collecting circuitry. A second terminal of the seventh resistor R7 and a second terminal of the third capacitor C3 are both grounded.

The fourth resistor R4, the fifth resistor R5, and the seventh resistor R7 form a series voltage divider circuit. When voltage at the first terminal of the fourth resistor R4 is greater than charging starting voltage, voltage at the first terminal of the seventh resistor R7 is greater than the preset value of division voltage, and the value corresponding to the acquisition signal output by the voltage acquisition circuitry of the solar panel 10 is greater than the charging starting value, the control circuitry 40 controls the solar panel 10 to charge the storage battery 30 through the charging management circuitry 20 according to the acquisition signal. The sixth resistor R6 is configured to convert a voltage signal into a current signal, and the third capacitor C3 is configured for filtering.

Further, referring to FIG. 3, in another embodiment, the power supply device further comprises a storage battery voltage collecting circuitry of 70, an input terminal of the storage battery voltage collecting circuitry 70 is connected to the positive electrode of the storage battery 30, and the output terminal of the storage battery voltage collecting circuitry 70 is connected to a second input terminal of the control circuitry 40.

The storage battery voltage collecting circuitry 70 is configured for collecting output voltage of the storage battery 30 and outputting corresponding acquisition signal to the control circuitry 40, so that the control circuitry 40 controls the working state of the charging management circuitry 20 according to the output voltage of the storage battery 30.

It can be understood that, when the storage battery 30 is full, the storage battery voltage collecting circuitry 70 can control the control circuitry 40 to disable the solar panel 10 to charge the storage battery 30 through the charging management circuitry 20 so as to avoid overcharge of the storage battery 30 and prolong the service life of the storage battery 30 and improve reliability of the power supply device. And when the storage battery 30 has a low battery, the control circuitry 40 controls the storage battery 30 to stop external powering.

Optionally, referring to FIG. 3, in another embodiment, the storage battery voltage collecting circuitry 70 comprises an eighth resistor R8, a ninth resistor R9, and a fourth capacitor C4. A first terminal of the eighth resistor R8 is the input terminal BT of the storage battery voltage collecting circuitry 70, a second terminal of the eighth resistor R8, a first terminal of the ninth resistor R9, and a first terminal of the fourth capacitor C4 are interconnected, the connection node thereof is the output terminal of storage battery voltage collecting circuitry 70. A second terminal of the ninth resistor R9 and a second terminal of the fourth capacitor C4 are both grounded.

The eighth resistor R8 and the ninth resistor R9 form a series voltage divider circuit. When voltage at the first terminal of the eighth resistor R8 is greater than a preset high voltage threshold, voltage at the first terminal of the ninth resistor R9 is also greater than a high preset threshold, and the value corresponding to the acquisition signal output by the storage battery voltage collecting circuitry 70 is greater than a preset high threshold, the control circuitry 40 can control the solar panel 10 to stop charging the storage battery 30 through the charging management circuitry 20 according to the acquisition signal. When voltage at the first terminal of the eighth resistor R8 is greater than a preset low voltage threshold, voltage at the first terminal of the ninth resistor R9 is also greater than a low preset threshold, and the value corresponding to the acquisition signal output by the storage battery voltage collecting circuitry 70 is greater than a preset low threshold, the control circuitry 40 can control the storage battery 30 to stop external powering according to the acquisition signal. The preset voltage threshold can be set according to a battery model, or a required driving voltage range of the load.

Optionally, referring to FIG. 3, in another embodiment, the control circuitry 40 includes a control chip U, a power pin VCC of the control chip U is the power supply terminal of the control circuitry 40, and a first control pin CT1 of the control chip is the first control terminal of the control circuit 40.

It is worth mentioning that the control chip U also includes a second control pin CT2, a first input pin AD1, a second input pin AD2, and an adjusting pin PWM. And the second control pin CT2 of the control chip U is the second control terminal of the control circuitry 40. The first input pin AD1 of the control chip U is the first input terminal of the control circuitry 40. The second input pin AD2 of the control chip U is the second input terminal of the control circuitry 40, the adjusting pin PWM of the control chip U is the adjusting terminal of the control circuitry 40.

Correspondingly, this disclosure also provides a lighting system.

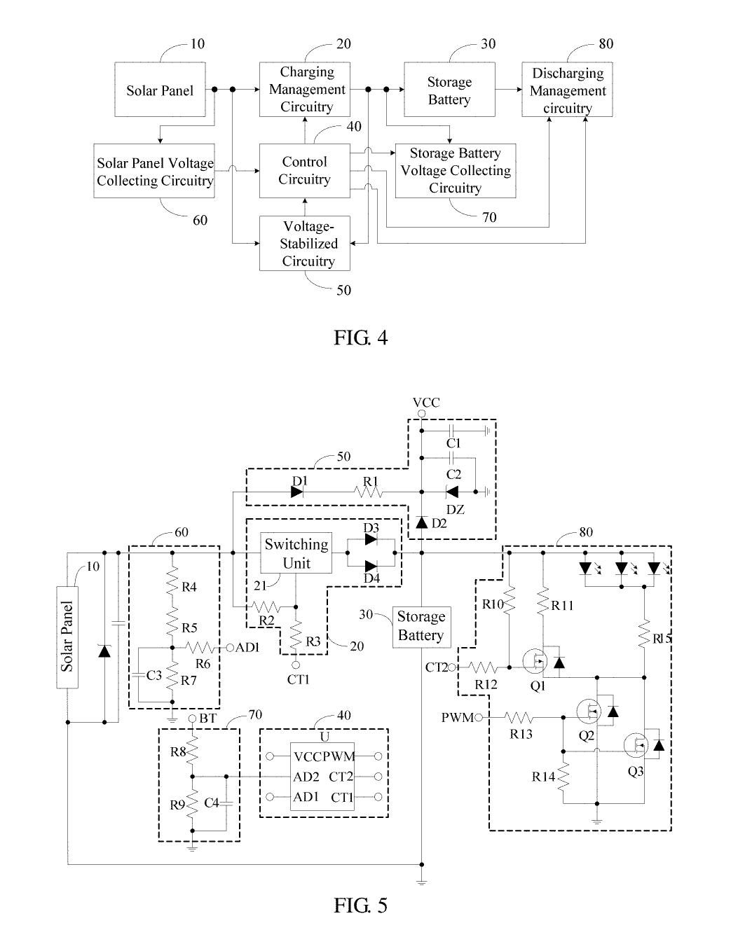

Referring to FIG. 4, in an embodiment, the lighting system includes a discharging management circuitry 80 and a power supply device described above, an input terminal of the discharging management circuitry 80 is connected to the positive electrode of the storage battery 30, an output terminal of the discharging management circuitry 80 is configured to output load power supply voltage, a controlled terminal of the discharging management circuitry 80 is connected to a second controlling terminal of the control circuitry 40, and an adjusted terminal of the discharging management circuitry 80 is connected to an adjusting terminal of the control circuitry 40.

The power supply device includes the solar panel 10, the storage battery 30, the charging management circuitry 20, the control circuitry 40 and the voltage-stabilized circuitry 50. The positive electrode of the solar panel 10, the input terminal of the charging management circuitry 20, and the first input terminal of the voltage-stabilized circuitry 50 are interconnected, the output terminal of the charging management circuitry 20, the positive electrode of the storage battery 30 and the second input terminal of the voltage-stabilized circuitry 50 are interconnected, the output terminal of the voltage-stabilized circuitry 50 is connected to the power supply terminal of the control circuitry 40, and the first controlling terminal of the control circuitry 40 is connected to the controlled terminal of the charging management circuitry 20. The voltage-stabilized circuitry 50 is configured for voltage stabilizing of electric energy output from the solar panel 10 or from the storage battery 30, and to output working power to the control circuitry 40; the control circuitry 40 is configured to control the working state of the charging management circuitry 20, allowing the solar panel 10 to charge the storage battery 30 through the charging management circuitry 20.

The load can be an incandescent, a halogen, etc. The following description based on an example of an LED lamp (a plurality of LED lamps connected in parallel as illustrated in FIG. 5) as the load.

Specifically, during the working process of the lighting system, by controlling the on-off state of the discharging management circuitry 80, the control circuitry 40 realizes the power supply device supplying power to the load through the discharging management circuitry 80, and realizes adjusting the load current through controlling the switching frequency of the discharging management circuitry 80.

Optionally, referring to FIG. 3, in another embodiment, the discharging management circuitry 80 includes a tenth resistor R10, an eleventh resistor R11, a twelfth resistor R12, a thirteenth resistor R13, a fourteenth resistor R14, a fifteenth resistor R15, a first transistor Q1, a second transistor Q2, and a third transistor Q3. A first terminal of the tenth resistor R10, a first terminal of the eleventh resistor R11, the positive electrode of load, and the positive electrode of the storage battery 30 are interconnected. A second terminal of the tenth resistor R10, a second terminal of the twelfth resistor R12 and a controlled terminal of the first transistor Q1 are interconnected. A first terminal of the twelfth resistor R12 is the controlled terminal of the discharging management circuitry 80. A second terminal of the eleventh resistor R11 is connected to an input terminal of the first transistor Q1. An output terminal of the first transistor Q1, a second terminal of the fifteenth resistor R15, a first terminal of the second transistor Q2 and a first terminal of the third transistor Q3 are interconnected. A first terminal of the fifteenth resistor R15 is connected to the positive electrode of the load. A controlled terminal of the second transistor Q2, a second terminal of the thirteenth resistor R13, a first terminal of the fourteenth resistor R14, and a controlled terminal of the third transistor Q3 are interconnected. A first terminal of the thirteenth resistor R13 is the adjusted terminal of the discharging management circuitry 80. A second terminal of the fourteenth resistor R14, an output terminal of the second transistor Q2, and an output terminal of the third transistor Q3 are all grounded.

The following description based on an example of a P-MOS transistor as the first transistor Q1, an N-MOS transistor as the second transistor Q2, an N-MOS transistor as the third transistor Q3. Herein, the gate is the controlled terminal, the drain is the input terminal, and the source is the output terminal, no matter it is the P-MOS transistor or the N-MOS transistor.

Specifically, when the voltage at the first terminal of the twelfth resistor R12 is high, the first transistor Q1 is cut off, the current output from the power supply device passes through the load, the second transistor Q2, and the third transistor Q3 to the ground; when the voltage at the first terminal of the twelfth resistor R12 is low, the first transistor Q1 is turned on, and the current output from the power supply device passes through the first transistor Q1, the second transistor Q2, and the third transistor Q3 to the ground. Throughout the entire process, brightness of the LED lamp could be adjusted by adjusting the duty cycle of on-time of the second transistor Q2 and the third transistor Q3.

Referring to FIG. 2 till FIG. 5, the operating principle of the power supply device and system of the present disclosure will be described below:

First, the voltage-stabilized circuitry 50 obtains input power from the solar panel 10 or from the storage battery 30, and performs voltage stabilizing processing on the input power, so as to output the working power of the control circuitry 40, and the control circuitry 40 starts.

Then, the solar panel 10 voltage collecting circuitry collects the output voltage of the solar panel 10, and outputs the corresponding acquisition signal to the control circuitry 40. When the value corresponding to the acquisition signal received by the first input terminal of the control circuitry 40 is greater than start-up value of charging, the control circuitry 40 controls the solar panel 10 to charge the storage battery 30 through the charging management circuitry 20.

Afterwards, the storage battery voltage collecting circuitry 70 collects the output voltage of the storage battery 30 and outputs the corresponding acquisition signal to the control circuitry 40. When the value corresponding to the acquisition signal received by the second input terminal of the control circuitry 40 is greater than preset value of threshold voltage, the control circuitry 40 disables the solar panel 10 to charge the storage battery 30 through the charging management circuitry 20.

When the storage battery 30 outputs voltage, the control circuitry 40 controls the discharging management circuitry 80 to turn on so that the power supply device supplies power to the load. Throughout the entire process, the control circuitry 40 can control the brightness of the LED lamp by adjusting the duty cycle of on-time of the discharging management circuitry 80; and the control circuitry 40 cuts off the power supply path of the load when it detects that the voltage of the storage battery 30 is too low.

The technical solution of the present disclosure has the following beneficial effects:

(1) The voltage-stabilized circuitry 50 obtains the input power from the solar panel 10 and the storage battery 30 at the same time, allowing the solar panel 10 to charge the storage battery 30 through the charging management circuitry 20 under low storage battery voltage conditions.

(2) The solar panel voltage collecting circuitry 60 is set, allowing the control circuitry 40 to control the solar panel 10 to charge the storage battery 30 through the charging management circuitry 20 during the daytime to increase the charging efficiency.

(3) The storage battery voltage collecting circuitry 70 is set, so that the control circuitry 40 controls the storage battery 30 to stop external power supplying (or enter the sleep mode) when detecting that the storage battery 30 has relatively low power, and the control circuitry 40 disables the solar panel 10 to charge the storage battery 30 through the charging management circuitry 20 when the storage battery 30 is full to extend the service life of the storage battery 30.

(4) The control circuitry 40 can adjust the brightness of the LED lamp by changing the duty cycle of on-time of the discharging management circuitry 80 to achieve PWM dimming and richen functions.

(5) The discharging management circuitry 80 is connected with the load in series. When the load is working, the voltage across the load is close to the output voltage of the storage battery 30, so that the loss of power is small.

(6) The entire circuitry does not include a boost module and a buck module, which is simple and efficient and easy to maintain.

The foregoing description portrays merely some illustrative embodiments of the present disclosure, and are not intended to limit the patentable scope of the present disclosure. Any equivalent structural or flow transformations based on the specification and the drawing of the present disclosure, or any direct or indirect applications of the present disclosure in other related technical fields, shall all fall within the protection scope of the present disclosure.

1-20. (canceled)

21. A power supply device, comprising:
a solar panel;
a storage battery;
a charging management circuitry;
a control circuitry; and
a voltage-stabilized circuitry;
wherein the positive electrode of the solar panel, an input terminal of the charging management circuitry, and a first input terminal of the voltage-stabilized circuitry are interconnected; an output terminal of the charging management circuitry, the positive electrode of the storage battery, and a second input terminal of the voltage-stabilized circuitry are interconnected; an output terminal of the voltage-stabilized circuitry is connected to a power supply terminal of the control circuitry; and a first control terminal of the control circuitry is connected to a controlled terminal of the charging management circuitry;
the voltage-stabilized circuitry is configured for voltage stabilizing of electric energy output from the solar panel or from the storage battery, and to output working power to the control circuitry;
the control circuitry is configured to control a working state of the charging management circuitry, allowing the solar panel to charge the storage battery through the charging management circuitry.

22. The power supply device according to claim 21, further comprising a solar panel voltage collecting circuitry, wherein an input terminal of the solar panel voltage collecting circuitry is connected to the positive electrode of the solar panel, and an output terminal of the solar panel voltage collecting circuitry is connected to a first input terminal of the control circuitry.

23. The power supply device according to claim 21, wherein the voltage-stabilized circuitry comprises:
a first diode;
a second diode;
a Zener diode;
a first capacitor;
a second capacitor; and
a first resistor;
the anode of the first diode is the first input terminal of the voltage-stabilized circuitry; a second terminal of the first diode is connected to a first terminal of the first resistor; a second terminal of the first resistor, the cathode of the second diode, the cathode of the Zener diode, a first terminal of the first capacitor, and a first terminal of the second capacitor are interconnected and the connection node thereof is the output terminal of the voltage-stabilized circuitry; the anode of the second diode is the second input terminal of the voltage-stabilized circuitry; the anode of the Zener diode, a second terminal of the first capacitor, and a second terminal of the second capacitor are interconnected.

24. The power supply device according to claim 23, further comprising a solar panel voltage collecting circuitry, wherein an input terminal of the solar panel voltage collecting circuitry is connected to the positive electrode of the solar panel, and an output terminal of the solar panel voltage collecting circuitry is connected to a first input terminal of the control circuitry.

25. The power supply device according to claim 21, wherein the charging management circuitry comprises:
a third diode;
a fourth diode;
a second resistor;
a third resistor; and
a switching unit;
a first terminal of the second resistor is connected to an input terminal of the switching unit and the connection node thereof is the input terminal of the charging management circuitry; an output terminal of the switching unit, the anode of the third diode, and the anode of the fourth diode are interconnected; the cathode of the third diode is connected to the cathode of the fourth diode and the connection node thereof is the output terminal of the charging management circuitry; a controlled terminal of the switching unit, a second terminal of the second resistor, and a first terminal of the third resistor are interconnected; and a second terminal of the third resistor is the controlled terminal of the charging management circuitry.

26. The power supply device according to claim 25, further comprising a solar panel voltage collecting circuitry, wherein an input terminal of the solar panel voltage collecting circuitry is connected to the positive electrode of the solar panel, and an output terminal of the solar panel voltage collecting circuitry is connected to a first input terminal of the control circuitry.

27. The power supply device according to claim 26, wherein the solar panel voltage collecting circuitry comprises:
a third capacitor;
a fourth resistor;
a fifth resistor;
a sixth resistor; and
a seventh resistor;
a first terminal of the forth resistor is the input terminal of the solar panel voltage collecting circuitry; a second terminal of the fourth resistor is connected to a first terminal of the fifth resistor; and a second terminal of the fifth resistor, a first terminal of the sixth resistor, a first terminal of the seventh resistor, and a first terminal of the third capacitor are interconnected; a second terminal of the sixth resistor is the output terminal of the solar panel voltage collecting circuitry; and a second terminal of the seventh resistor and a second terminal of the third capacitor are both grounded.

28. The power supply device according to claim 21, further comprising a storage battery voltage collecting circuitry, an input terminal of the storage battery voltage collecting circuitry is connected to the positive electrode of the storage battery, and an output terminal of the storage battery voltage collecting circuitry is connected to a second input terminal of the control circuitry.

29. The power supply device according to claim 28, wherein the storage battery voltage collecting circuitry comprises:
an eighth resistor;
a ninth resistor; and
a fourth capacitor;
a first terminal of the eighth resistor is the input terminal of the storage battery voltage collecting circuitry, a second terminal of the eighth resistor, a first terminal of the ninth resistor, and a first terminal of the fourth capacitor are interconnected and the connection node thereof is the output terminal of the storage battery voltage collecting circuitry; and a second terminal of the ninth resistor and a second terminal of the fourth capacitor are both grounded.

30. The power supply device according to claim 21, wherein the control circuitry comprises a control chip, a power pin of the control chip is the power supply terminal of the control circuitry, and a first control pin of the control chip is the first control terminal of the control circuit.

31. A lighting system, comprising:
a discharging management circuitry; and
a power supply device, the power supply device comprising: a solar panel, a storage battery, a charging management circuitry, a control circuitry and a voltage-stabilized circuitry;
wherein the positive electrode of the solar panel, an input terminal of the charging management circuitry, and a first input terminal of the voltage-stabilized circuitry are interconnected; an output terminal of the charging management circuitry, the positive electrode of the storage battery, and a second input terminal of the voltage-stabilized circuitry are interconnected; an output terminal of the voltage-stabilized circuitry is connected to a power supply terminal of the control circuitry; and a first control terminal of the control circuitry is connected to a controlled terminal of the charging management circuitry; the voltage-stabilized circuitry is configured for voltage stabilizing of electric energy output from the solar panel or from the storage battery, and to output working power to the control circuitry; the control circuitry is configured to control a working state of the charging management circuitry, allowing the solar panel to charge the storage battery through the charging management circuitry;
an input terminal of the discharging management circuitry is connected to the positive electrode of the storage battery, an output terminal of the discharging management circuitry is configured to output a load power supply voltage, a controlled terminal of the discharging management circuitry is connected to a second control terminal of the control circuitry, and an adjusted terminal of the discharging management circuitry is connected to an adjusting terminal of the control circuitry.

32. The lighting system according to claim 31, wherein the discharging management circuitry comprises:
a tenth resistor;
an eleventh resistor;
a twelfth resistor;
a thirteenth resistor;
a fourteenth resistor;
a fifteenth resistor;
a first transistor;
a second transistor; and
a third transistor; wherein a first terminal of the tenth resistor, a first terminal of the eleventh resistor, an positive electrode of a load, and the positive electrode of the storage battery are interconnected; a second terminal of the tenth resistor, a second terminal of the twelfth resistor, and a controlled terminal of the first transistor are interconnected; a first terminal of the twelfth resistor is the controlled terminal of the discharging management circuitry; a second terminal of the eleventh resistor is coupled to an input terminal of the first transistor; an output terminal of the first transistor, a second terminal of the fifteenth resistor, a first terminal of the second transistor, and a first terminal of the third transistor are interconnected; a first terminal of the fifteenth resistor is coupled to the positive electrode of the load; a controlled terminal of the second transistor, a second terminal of the thirteenth resistor, a first terminal of the fourteenth resistor, and a controlled terminal of the third transistor are interconnected; a first terminal of the thirteenth resistor is the adjusted terminal of the discharging management circuitry; and a second terminal of the fourteenth resistor, an output terminal of the second transistor, and an output terminal of the third transistor are all grounded.

33. The lighting system according to claim 31, wherein further comprising a solar panel voltage collecting circuitry, wherein an input terminal of the solar panel voltage collecting circuitry is connected to the positive electrode of the solar panel, and an output terminal of the solar panel voltage collecting circuitry is connected to a first input terminal of the control circuitry.

34. The lighting system according to claim 33, wherein the voltage-stabilized circuitry comprises:
a first diode;
a second diode;
a Zener diode;
a first capacitor;
a second capacitor; and
a first resistor;
the anode of the first diode is the first input terminal of the voltage-stabilized circuitry; a second terminal of the first diode is connected to a first terminal of the first resistor; a second terminal of the first resistor, the cathode of the second diode, the cathode of the Zener diode, a first terminal of the first capacitor, and a first terminal of the second capacitor are interconnected and the connection node thereof is the output terminal of the voltage-stabilized circuitry; the anode of the second diode is the second input terminal of the voltage-stabilized circuitry; the anode of the Zener diode, a second terminal of the first capacitor, and a second terminal of the second capacitor are interconnected.

35. The lighting system according to claim 31, wherein the charging management circuitry comprises:
a third diode;
a fourth diode;
a second resistor;
a third resistor; and
a switching unit;
a first terminal of the second resistor is connected to an input terminal of the switching unit and the connection node thereof is the input terminal of the charging management circuitry; an output terminal of the switching unit, the anode of the third diode, and the anode of the fourth diode are interconnected; the cathode of the third diode is connected to the cathode of the fourth diode and the connection node thereof is the output terminal of the charging management circuitry; a controlled terminal of the switching unit, a second terminal of the second resistor, and a first terminal of the third resistor are interconnected; and a second terminal of the third resistor is the controlled terminal of the charging management circuitry.

36. The lighting system according to claim 35, wherein the solar panel voltage collecting circuitry comprises:
a third capacitor;
a fourth resistor;
a fifth resistor;
a sixth resistor; and
a seventh resistor;
a first terminal of the forth resistor is the input terminal of the solar panel voltage collecting circuitry; a second terminal of the fourth resistor is connected to a first terminal of the fifth resistor; and a second terminal of the fifth resistor, a first terminal of the sixth resistor, a first terminal of the seventh resistor, and a first terminal of the third capacitor are interconnected; a second terminal of the sixth resistor is the output terminal of the solar panel voltage collecting circuitry; and a second terminal of the seventh resistor and a second terminal of the third capacitor are both grounded.

37. The lighting system according to claim 31, wherein further comprising a storage battery voltage collecting circuitry, an input terminal of the storage battery voltage collecting circuitry is connected to the positive electrode of the storage battery, and an output terminal of the storage battery voltage collecting circuitry is connected to a second input terminal of the control circuitry.

38. The lighting system according to claim 37, wherein the storage battery voltage collecting circuitry comprises:
an eighth resistor;
a ninth resistor; and
a fourth capacitor;
a first terminal of the eighth resistor is the input terminal of the storage battery voltage collecting circuitry, a second terminal of the eighth resistor, a first terminal of the ninth resistor, and a first terminal of the fourth capacitor are interconnected and the connection node thereof is the output terminal of the storage battery voltage collecting circuitry; and a second terminal of the ninth resistor and a second terminal of the fourth capacitor are both grounded.

39. The lighting system according to claim 31, wherein the control circuitry comprises a control chip, a power pin of the control chip is the power supply terminal of the control circuitry, and a first control pin of the control chip is the first control terminal of the control circuit.
